(19) United States
(12) Patent Application Publication
(10) Pub. No.: US 2012/0282787 A1
(43) Pub. Date: Nov. 8, 2012

(54) AT LEAST PARTIALLY REDUNDANT INTERCONNECTS BETWEEN COMPONENT AND PRINTED BOARD

(75) Inventor: Jay Stanke, Albuquerque, NM (US)

(73) Assignee: HONEYWELL INTERNATIONAL INC., Morristown, NJ (US)

(21) Appl. No.: 13/460,599

(22) Filed: Apr. 30, 2012

Related U.S. Application Data
(60) Provisional application No. 61/482,446, filed on May 4, 2011.

(51) Int. Cl. H01R 12/71

(52) U.S. Cl. 439/65

(57) ABSTRACT

A printed board assembly includes a printed board, an electrical component, a first interconnect that electrically connects the component to the printed board, and a second interconnect that electrically connects the first interconnect to the printed board. In some examples, the second interconnect extends between the first interconnect and the same electrical contact on the printed board to which the first interconnect is electrically connected. The first and second interconnects provide an at least partially redundant electrical pathway between the component and the printed board.

This application claims the benefit of U.S. Provisional Patent Application Ser. No. 61/482,446 by Jay Stanke, which was filed on May 4, 2011, and is entitled “REDUNDANT INTERCONNECTS BETWEEN COMPONENT AND PRINTED BOARD.” U.S. Provisional Application Ser. No. 61/482,446 by Jay Stanke is incorporated herein by reference in its entirety

### TECHNICAL FIELD

The disclosure relates to a printed board assembly that includes a component and a printed board.

### BACKGROUND

In some existing printed board assemblies, an electrical component is mounted to a surface of a printed board and is electrically connected to the printed board, e.g., via a lead that extends between the component and the surface of the printed board or between the component and a through hole via defined by the printed board. The lead may be soldered to an electrically conductive contact (e.g., a pad) on the printed board or to a surface of the through hole via.

### SUMMARY

In general, the disclosure is directed to techniques and structure (e.g., devices and systems) for electrically connecting an electrical component (e.g., a package including one or more integrated circuit die) to a printed board. In some examples, a first interconnect (also referred to herein as a primary interconnect), such as a lead, electrically connects the component to the printed board. For example, the first interconnect can be electrically connected to the component and an electrically conductive contact (e.g., a pad on a surface) on the printed board. In addition, a second interconnect (also referred to herein as a secondary interconnect) can also be used to electrically connect the component to the printed board. In some examples, the second interconnect electrically connects the printed board to the first interconnect, e.g., by extending between the first interconnect and the same conductive contact on the printed board to which the first interconnect is electrically connected. If and when the electrical connection between the first interconnect and the conductive pad on the printed board fails, e.g., due to multiple stress and strain cycles of the printed board assembly, the electrical connection between the component and the printed board may be maintained via the second interconnect. In this way, the first and second interconnects provide at least partially redundant electrical pathways between the component and the printed board.

In some examples, the second interconnect is more flexible than the first interconnect, such that the second interconnect is not subjected to the same mechanical stresses as the first interconnect during stress and strain cycles. In some examples, the second interconnect is a flexible circuit (also referred to herein as a “flex-circuit”).

In some examples, a printed board assembly includes both the first and second interconnects that connect a component to a printed board. In other examples, the printed board assembly includes only the second interconnect (e.g., a flexible circuit) to connect the component to the printed board. In these examples, the second interconnect extends directly between the component and the printed board.

In one example, the disclosure is directed to an assembly (e.g., a circuit assembly) comprising a printed board, an electrical component, a first interconnect electrically connecting the electrical component to the printed board and a second interconnect electrically connecting the printed board and the first interconnect. The first and second interconnects are configured to provide at least partially redundant electrical pathways between the component and the printed board. In some examples, the first and second interconnects electrically connect to the same electrical contact pad of the printed board.

In another example, the disclosure is directed to a system comprising a printed board, an electrical component, means for electrically connecting the electrical component to the printed board, and means for electrically connecting the printed board and the means for electrically connecting the electrical component to the printed board. The means for electrically connecting the electrical component to the printed board and the means for electrically connecting the printed board and the means for electrically connecting the electrical component to the printed board provide at least partially redundant electrical pathways between the electrical component and the printed board.

In another example, the disclosure is directed to a method comprising electrically connecting a first interconnect to a printed board, electrically connecting the first interconnect to an electrical component, electrically connecting a second interconnect to the printed board, and electrically connecting the second interconnect to the first interconnect to define at least partially redundant electrical pathways from the electrical component to the printed board.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a perspective view of an example printed board assembly that includes an electrical component mounted on a printed board and electrically connected to the printed board via a plurality of first interconnects.

FIG. 2 is a side view of the printed board assembly of FIG. 1.

FIG. 3 is a side view of an example printed board assembly that includes an electrical component mounted on a printed board and electrically connected to the printed board via a plurality of first interconnects and a plurality of second interconnects that electrically connect the first interconnects to the printed board.

FIG. 4 is a flow diagram of an example technique for forming the printed board assembly shown in FIG .3.

FIG. 5 is a side view of another example printed board assembly that includes an electrical component mounted on a printed board and electrically connected to the printed board via a plurality of first interconnects and a plurality of second interconnects that electrically connect the first interconnects to the printed board, where the second interconnects are a part of a flexible circuit.

FIG. 6 is a side view of the printed board assembly shown in FIG. 5 and illustrates a secondary electrical path when the first electrical path is broken due to, e.g., mechanical and thermal stresses.

FIGS. 7 and 8 are perspective views of an example flexible circuit that may be used as a second interconnect in a printed board assembly.

FIG. 9 is a perspective view of the flexible circuit shown in FIGS. 7 and 8, and an electrical component prior to forming an electrical connection between each trace of the flexible circuit and respective lead attached to the component.

FIG. 10 is a perspective view of the flexible circuit and electrical component shown in FIG. 9, where ends of the flexible circuit are folded over and traces of the flexible circuit are aligned with leads attached to the component.

FIG. 11 is a flow diagram of an example technique for forming a printed board assembly that includes a lead that electrically connects an electrical component to a printed board and a flexible circuit that defines a separate electrically connection between the lead and the printed board.

FIGS. 12 and 13 are perspective views of a portion of an example printed board assembly, which includes a flexible circuit and an electrical component.

FIG. 14 is a side view of another example printed board assembly that only includes one electrical pathway between an electrical component and a printed board, where the electrical pathway is defined by a flexible circuit.

FIG. 15 is a side view of another example printed board assembly that only includes one electrical pathway between an electrical component and a printed board, where the electrical pathway is defined by a flexible circuit, and where the flexible circuit is in a different orientation relative to the printed board assembly shown in FIG. 14.

The drawings are simplified for ease of description of some of features of the printed board assemblies. In other examples, printed board assemblies may have a greater or fewer numbers of components.

### DETAILED DESCRIPTION

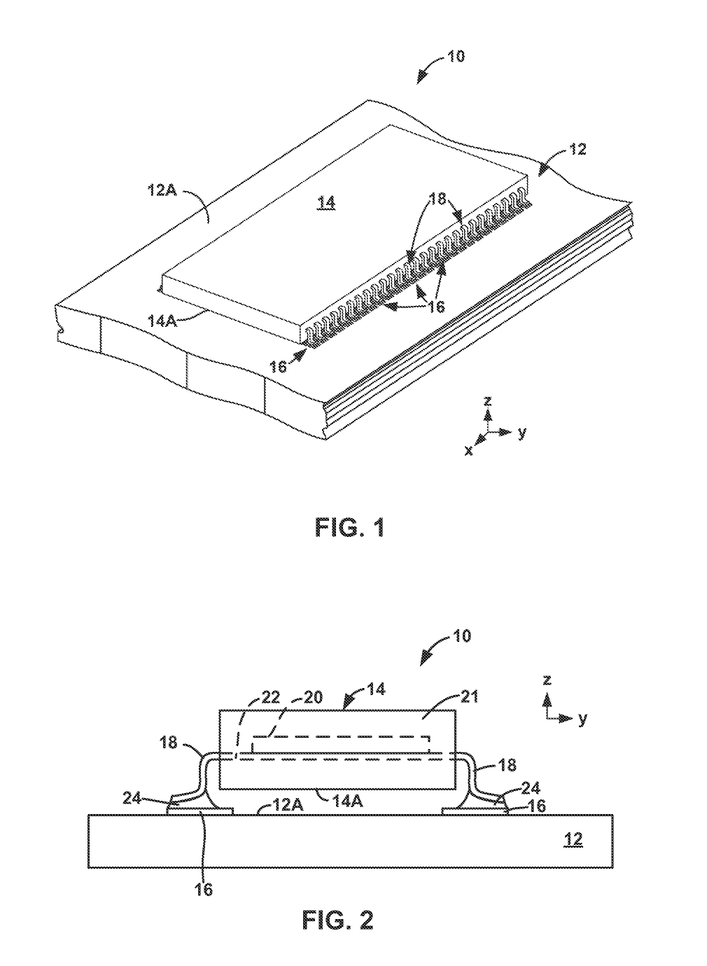

FIG. 1 is a perspective view of an example printed board assembly 10 that includes printed board 12 and electrical component 14. FIG. 2 is a side view of printed board assembly 10. Printed board 12 may be, for example, a printed circuit board or printed wiring board that is configured to mechanically support and electrically connect electronic components together using conductive pathways (e.g., conductive traces and vias). In some examples, the conductive pathways of printed board 12 are etched from a electrically conductive material (e.g., copper sheets) laminated onto a nonconductive substrate.

As shown in FIG. 1, printed board 12 includes a plurality of electrically conductive pads 16, which are configured to electrically connect to one or more conductive pathways (not shown) of printed board 12 (e.g., defined by electrically conductive vias and traces within one or more insulative layers of printed board 12). In the example shown in FIG. 1, electrical component 14 is mounted to a top surface 12A of printed board 12 and electrically connects to printed board 12 via a plurality of leads 18. In the example shown in FIGS. 1 and 2, each lead 18 electrically connects electrical component 14 to a respective electrically conductive pad 16 of printed board 12. Accordingly, each lead 18 extends between component 14 and a respective pad 16 of printed board 12.

Although the examples described herein primarily refer to electrically conductive pads 16 on a surface of printed board 12, in other examples, electrical connections to printed board 12 may be defined by other types of electrically conductive contacts in addition to or instead of pads 16. The electrically conductive contacts can have any suitable configuration and may be electrically connected to electrically conductive traces, vias, or both, of printed board 12.

In other examples, two or more leads 18 may electrically connect to a common conductive pad 16 or each lead 18 may electrically connect to more than one conductive pad 16. In the example shown in FIG. 1, printed board assembly 10 includes 56 or more leads 18. In other examples of printed board assembly 10, a greater or fewer number of leads 18 (e.g., a single lead or two leads, 48 leads, or greater than 56 leads) may be used to electrically connect electrical component 14 to printed board 12.

Electrical component 14 may be any suitable electrical component, such as, but not limited to, one or more integrated circuits, one or more integrated circuits housed within a package, inductors, storage memory (e.g., random access memory), capacitors, resistance banks, diodes, and the like. In the example shown in FIGS. 1 and 2, electrical component 14 is a surface mount component, i.e., is configured to be mounted to a surface of printed board 12 and electrically connect to a conductive pad 16 on top surface 12A, rather than electrically connecting to printed board 12 via through-hole technology, in which leads 18 are inserted into holes defined by printed board 12. Electrical component 14 defines at least one terminal for electrically connecting component 14 to printed board 12. In the example shown in FIG. 1, leads 18 extend from respective terminals to respective pads 16. Other configurations are contemplated.

In other examples, electrical component 14 may be electrically connected to printed board 12 using other technologies, such as a through-hole technology. For example, electrical component 14 may be electrically connected to a conductive surface of a through-hole or to a conductive pad on the opposite side of printed board 12 from component 14 (in which case, leads 18 may extend through through-holes defined by printed board 12 to the other side of printed board 12). In addition, or instead, electrical component 14 may be electrically connected to printed board 12 using a blind hole, which differs from a through-hole in that the blind hole does not extend all the way through printed board 12.

As shown in FIG. 2, the example electrical component 14 shown in FIGS. 1 and 2 includes integrated circuit 20, package 21, and lead frame 22, which defines one or more electrical terminals that are electrically connected to integrated circuit 20. Thus, electrically connecting lead 18 to lead frame 22 electrically connects lead 18 to integrated circuit 20. Package 21 is configured to house integrated circuit 20, and, in the example shown in FIG. 1, substantially surrounds (e.g., completely surrounds, such as with the aid of a package lid, or nearly completely surrounds) integrated circuit 20. While package 21 may have any suitable size relative to integrated circuit 20 (but sized large enough to receive integrated circuit 20), in the example shown in FIGS. 1 and 2, a dimension of integrated circuit 20 in the x-y plane (orthogonal x-y-z axes are shown in FIGS. 1 and 2 for ease of description only) may be 50% or more of the dimension of package 21 in the x-y plane. In other examples, package 21 may house more than one integrated circuit, such as a stack (in the z-axis direction) of two or more integrated circuits or an array of integrated circuits that extends in the x-y plane.

In some examples, electrical component 14 is secured to printed board 12 using a mechanical fixation mechanism in addition to the mechanical coupling provided by the mechanical connection between leads 18, component 14, and conductive pads 16. For example, an adhesive may be positioned between a bottom surface 14A of component 14 and top surface 12A of printed board 12 to adhere component 14 to printed board 12. Other techniques can also be used in addition to or instead of an adhesive. For example, electrical component may define pins that are received by recesses defined by printed board 12, where the pins snap fit in the recess, fit by friction fit in the recesses or otherwise engage to substantially fix the position of component 14 relative to printed board 12.

Each lead 18 comprises an electrically conductive material. For example, leads 18 may be comprised of a nickel iron alloy (e.g., Alloy 42, which may be comprised of about 57.5 weight percent iron, about 0.4 weigh percent manganese, about 0.2 weight percent silicon with other trace elements and the remainder nickel) or a copper alloy (e.g., C194, which comprises about 2.4 weight percent iron, about 0.04 weight percent phosphorus, about 0.13 weight percent zinc, and a balance of copper). Other electrically conductive materials are also contemplated. In some examples, an electrically insulating material may surround at least a part of each lead 18 in order, for example, to help electrically isolate leads 18 from each other or from other components of assembly 10.

Each lead 18 is electrically connected to an electrical terminal or the like of electrical component 14. In the example shown in FIGS. 1 and 2, component 14 comprises an integrated circuit package comprising leads 18, lead frame 22, and integrated circuit 20, where each lead 18 electrically connects to integrated circuit die 20 via a standard lead frame 22. In some examples, lead frame 22 comprises the same material as lead 18, such as the materials described above. In the example shown in FIGS. 1 and 2, leads 18 are arranged in a gull wing shape, in which each lead 18 extends slightly out from component 14, down (towards printed board 12), and then out away from component 14 again. Other lead configurations are contemplated and may be used depending upon the type of printed board assembly, the type of component, and other factors, such as the congestion of electrical components on printed board 12.

In the example shown in FIGS. 1 and 2, leads 18 are soldered to conductive pads 16 of printed board 12. In particular, a solder joint 24 comprised of solder is positioned between an end of a lead 18 and a respective conductive pad 16. Assembly 10 includes a plurality of solder joints 24, e.g., one for each lead 18 and conductive pad 16 pair in examples in which each lead 18 is electrically connected to a respective conductive pad 16. The portion of solder joint 24 nearest the end of the respective lead 18 can be referred to as the toe of the solder joint, the area of solder joint 24 under the length of the respective lead 18 most adjacent to conductive pad 16 pad can be referred to as the foot of the solder joint, and the solder fillet nearest the component 14 can be referred to as the heel of the solder joint.

Solder joint 24 is electrically conductive and defines an electrically conductive pathway between a lead 18 and respective conductive pad 16 of printed board 12. In addition, solder joint 24 provides a mechanical connection between each lead 18 and a respective conductive pad 16 of printed board 12. Solder joint 24 may be formed using any suitable solder technique, such as using a high temperature solder or a eutectic solder that is subsequently reflowed.

In some printed board assemblies 10, printed board 12 has a different coefficient of thermal expansion (CTE) than component 14. For example, printed board 12 may have a relatively high CTE relative to component 14, such as a CTE greater than or equal to about 18 parts per million per degree Celsius (ppm/° C.), such as 18 ppm/° C., about 19 ppm/° C. (e.g., 19 ppm/° C. or nearly 19 ppm/° C.), or about 22 ppm/° C. (e.g., 22 ppm/° C. or nearly 22 ppm/° C.). Component 14 may have a low CTE relative to the printed board 12, such as a CTE less than or equal to about 12 ppm/° C., such as 12 ppm/° C. or about 11 ppm/° C. (e.g., 11 ppm/° C. or nearly ppm/° C.). Printed board 12 may be formed from, for example, a glass epoxy (e.g., FR-4, which is made of woven fiberglass cloth with an epoxy resin binder, or polyimide glass epoxy). Printed boards with relatively low CTEs, such as CTEs that are closer to the CTE of component 14 and/or lead 18, may be relatively expensive. Thus, some manufacturers may include a relatively high CTE printed board 12 in printed board assembly 10 to lower the cost of assembly 10.

In addition, in some examples, component 14 may have a relatively low CTE. For example, in examples in which component 14 comprises package 21 housing at least one integrated circuit 20, and integrated circuit die 20 is formed from a ceramic substrate and is relatively large compared to package 21, component 14 may behave as if it is a ceramic part. That is, the CTE of integrated circuit 20 may influence the CTE of the entire component 14 in examples in which integrated circuit 20 is relatively large compared to package 21. An example of an integrated circuit 20 that is relatively large compared to package 21 may be, for example, an integrated circuit 20 that has a surface area in the x-y plane that is 50% of the surface area of package 21 in the x-y plane or greater than 50% of the surface area of package 21 in the x-y plane. The surface area may be, for example, the cross-sectional surface area of integrated circuit 20 and package 21 in the x-y plane or a surface area of a major surface of the integrated circuit 20 and package 21 generally in the x-y plane (e.g., a bottom surface of package 21 and integrated circuit 20 shown in FIG. 2).

The relatively low CTE of component 14 may be at least partially attributable to the CTE of integrated circuit 20, which may be formed from a substrate of semiconductor material. In addition, the relatively large size of integrated circuit 20 relative to package 21 may increase the stiffness of component 14. Some thin small outline packages (TSOP), such as some integrated circuit packages, may have a CTE of about 7 ppm/° C.

The CTE of lead 18 and lead frame 22 may be closer to the CTE of component 14 than printed board 12. In some examples, the CTE of lead 18 and lead frame 22 may even substantially match (e.g., match or nearly match, such that the thermal expansion behaviors are the same) the CTE of component 14. The CTE of lead 18 may be selected in some cases to accommodate the mounting of component 14 to printed board 12.

Printed board assembly 10 may be subjected to multiple thermal cycles, e.g., during the life of printed board assembly 10 or during the operation of a device in which printed board assembly 10 is incorporated. For example, if printed board 10 is incorporated in a device, during operation of the device, printed board assembly 10 may be subjected to multiple heating and cooling cycles. The heat may be at least partially generated by component 14 and other components on printed board 12 or components of nearby printed board assemblies or other components of the device. Due to the CTE mismatch between printed board 12 and component 14, component 14 and printed board 12 may expand and contract at different rates during these thermal cycles. As discussed in further detail below, the relative expansion and contraction of printed board 12 and component 14 may generate stress and strain forces at solder joint 24, which may compromise the integrity of solder material 24. If the integrity of solder material 24 is compromise to the extent that there is a disruption in the electrical pathway from conductive pad 16 to lead 18, the electrical connection between component 14 and printed board 12 may be disrupted, e.g., terminated or at least partially interrupted.

Although one component 14 is shown mounted on printed board 12, in some examples, printed board 12 includes a plurality of components mounted next to each other. In order to increase the density of printed board assemblies, the size of leads 18 may be decreased in order to reduce congestion on printed board 12. As the length of leads 18 is shortened (decreased), leads 18 may be less capable of accommodating the different rates of expansion/contraction between component 14 and printed board 12. For example, leads 18 may have greater spring tension due to the shorter length, such that upon a certain threshold amount of movement between printed board 12 and component 14, the integrity of solder joint 24 providing a mechanical and electrical connection between leads 18 and respective conductive pads 16 may be compromised and may even fracture. Some leads 18 may act as springs and the solder between leads 18 and printed board 12 may be a visco-plastic medium, and, as a result, the solder may relax under strain and relieve under stress. As the solder goes through this cycling, depending on how hard the spring formed by the lead 18 pushes the solder grain boundaries grow, the solder may change form and may even begin cracking The cracking of the solder may cause disruptions in the electrical connection between component 14 and printed board 12.

In addition, in some examples, leads 18 are formed from a relatively stiff material for ease of manufacturing. For example, leads 18 formed from a relatively stiff material may be easier to manipulate during assembly of printed board assembly 10 compared to a more flexible lead. The relatively stiff leads 18 may further decrease the ability of leads 18 to accommodate relative movement between printed board 12 and component, e.g., due to the different CTEs. Due to the geometry and high modulus of elasticity of leads 18 in some examples, the spring stiffness of leads 18 may be too high to accommodate strain in the solder joint 24.

The relative expansion and contraction of printed board 12 and component 14 may generate stress and strain forces in the solder joint 24, thereby resulting in a cracking or other disruption in solder joint 24. In some situations, solder joints 24 at corners of component 14 may fail (e.g., crack) first. As assembly 10 heats up, component 14 expands from its neutral point relative to the printed board 12. In some cases, if component 14 is mounted to printed board 12 at its corners, e.g., as shown in FIG. 1 with the leads 18 at corners of component 14, the highest strain may be on the leads furthest from the neutral point, thereby resulting in failure of solder joints 24 at corners (e.g., the first three to four solder joints 24 at each corner) of component 14 prior to failure of other solder joints.

In addition to a CTE mismatch between printed board 12 and component 14, a CTE mismatch between different elements of printed board assembly 10 may contribute to the failure of solder joint 24, resulting in a disruption in the electrical path from lead 18 to conductive pad 16. The CTE mismatch may be considered to be “global” in the case of the CTE mismatch between printed board 12 and component 14. Examples of “local” CTE mismatch that may also contribute to the failure of solder joint 24 include, but are not limited to, CTE mismatches between lead 18 and solder joint 24, between conductive pad 16 and solder joint 24, and between conductive pad 16 and the other portions of printed board 12.

In printed board assembly 10 shown in FIGS. 1 and 2, the only electrical pathway between component 14 and a particular conductive pad 16 is provided through a single lead 18 and a single solder joint 24. Thus, when a solder joint 24 between a lead 18 and conductive pad 16 of printed board 12 fails, e.g., due to cracking, the electrical connection between component 14 and printed board 12 provided by the solder joint 24 is disrupted. In some cases, the failure of solder joint 24 may completely terminate the electrical connection or a key electrical connection between component 14 and printed board 12, resulting in signal loss for component 14. Thus, when solder joint 24 fails, the life of printed board assembly 10 may be prematurely ended.

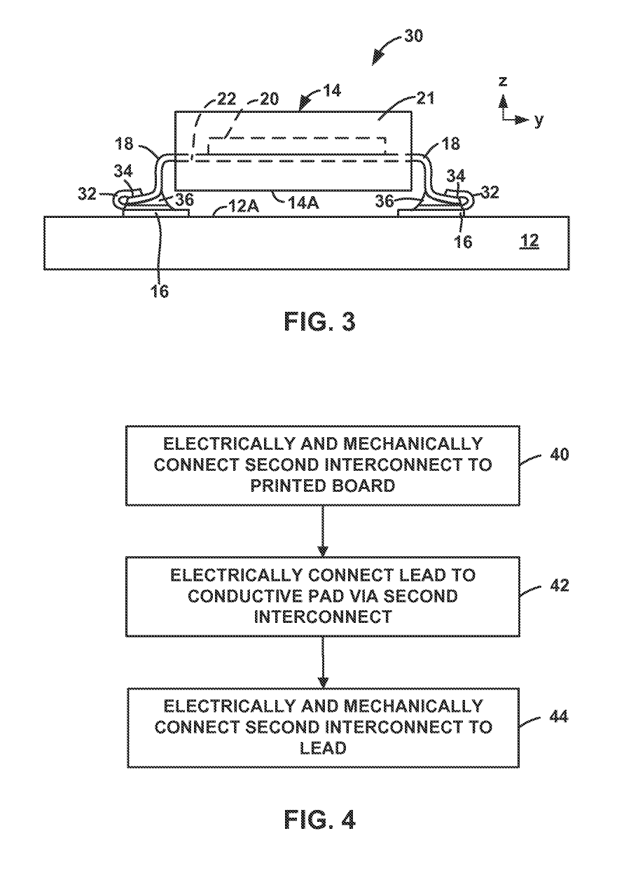

In example printed board assemblies described herein, a printed board assembly includes at least partially redundant (e.g., partially redundant or redundant) electrical pathway between electrical component 14 and a conductive pad 16 of printed board 12. In addition to a first (or primary) interconnect (e.g., a solder joint 36 on the lead 18) between component 14 and a conductive pad 16 of printed board 12, a printed board assembly can include a second interconnect in parallel with the first interconnect between the lead 18 and conductive pad 16. The second interconnect may be redundant to at least a part of an electrical pathway that includes lead 18. An example of such a printed board assembly is shown in FIG. 3, which is a side view of printed board assembly 30.

Printed board assembly 30 includes printed board 12, which includes conductive pad 16, component 14, and lead 18, which are described with respect to FIG. 1. In addition, printed board assembly 30 includes a plurality of second interconnects 32, which each defines a parallel, electrically conductive pathway from a conductive pad 16 to a respective lead 18. Thus, in the example shown in FIG. 3, second interconnects 32 also define part of an electrically conductive pathway from component 14 to conductive pad 16. In some examples, printed board assembly 30 may include one second interconnect 32 for each conductive pad 16 and lead 18 pair. In other examples, only some of the conductive pad 16 and lead 18 pairs may be associated with a respective second interconnect 32. For example, the higher priority electrically conductive pathways may be selected to include second interconnects 32. Other configurations of second interconnects 32 are also contemplated.

As discussed above, in some examples, a single lead 18 may electrically connect to a single conductive pad 16, more than one conductive pad 16, or two or more leads 18 may electrically connect to a single conductive pad 16. In each of these examples, second interconnects 32 may be appropriately configured to provide an electrical pathway from the lead 18 to the appropriate conductive pads 16 of printed board 12 that is at least partially redundant to the pathway provided by lead 18. Second interconnects 32 may provide partially redundant pathways or fully redundant pathways, depending on where interconnect 32 connects to electrical component 14 and conductive pad 16.

In the example shown in FIG. 3, each second interconnect 32 may define a single electrical pathway, such that anything in electrical contact with one portion of second interconnect 32 is in electrical contact with another portion of second interconnect 32 and anything else electrically connected to second interconnect 32. For ease of description, one second interconnect 32 is described below; the other second interconnects of printed board assembly 30 may be similar to the described second interconnect 32.

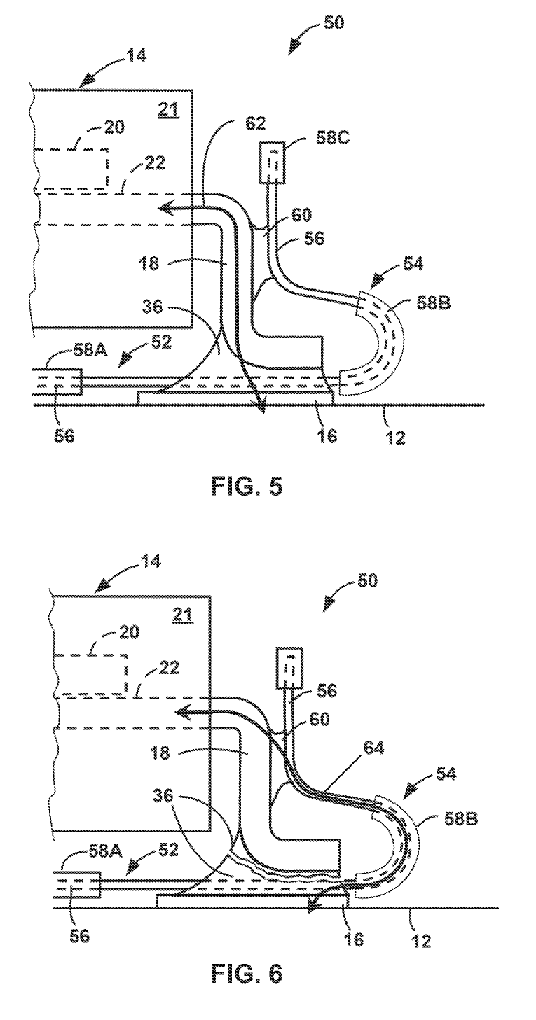

Second interconnect 32 can comprise any suitable electrically conductive material. In some examples, at least a portion of second interconnect 32 is electrically insulated, e.g., to provide electrical isolation between adjacent second interconnects 32. Second interconnect 32 includes exposed electrically conductive portions that are in contact with both conductive pad 16 and lead 18, as well as with solder joint 36. In some examples, second interconnect 32 is more flexible than lead 18, e.g., compared to lead 18, second interconnect 32 may bend more easily and repeatedly with the cyclic application of force and subsequently transfer less strain into the solder joints 36 and 60 (described with respect to FIG. 5) without breakage. An example of one type of second interconnect 32 is a flexible circuit, which can include a patterned arrangement of printed wiring (e.g., copper traces) in a flexible, electrically insulative substrate (e.g., Kapton).

In the example shown in FIG. 3, second interconnect 32 is soldered to (e.g., directly to) conductive pad 16, and lead 18 is soldered to conductive pad 16 through second interconnect 32, which is positioned between lead 18 and conductive pad 16. As a result, lead 18 electrically connects to conductive pad 16 through second interconnect 32. That is, lead 18 is positioned over conductive pad 16 in the same manner as in printed board assembly 10 (FIGS. 1 and 2), but second interconnect 32 is positioned between lead 18 and conductive pad 16. The electrical pathway from lead 18 to conductive pad 16 is relatively short (i.e, shorter than the length of second interconnect 32 between contact pad 16 and lead 18) despite the electrical connection being formed through second interconnect 32 because the smaller dimension of second interconnect 32 (e.g., the width or thickness) is positioned between lead 18 and conductive pad 16. This smaller dimension may be measured, for example, in a direction substantially perpendicular to a length of second interconnect 32.

In some examples, interconnect 32 is perforated (e.g., substantially noncontinuous and/or defining openings through a thickness of interconnect 32), such that lead 18 may be soldered directly to contact pad 16 through the perforations in second interconnect 32. All of second interconnect 32 may be perforated in some examples, while in other examples, only part of second interconnect 32 may be perforated, such as the portion positioned between lead 18 and conductive pad 16.

Second interconnect 32 can have any suitable size relative to lead 18 and pad 16. In the example shown in FIG. 3, second interconnect 32 is soldered to lead 18 at interface 34, and, therefore, second interconnect 32 is mechanically and electrically connected to lead 18 at interface 34. Thus, second interconnect 32 indirectly electrically connects to component 14 via lead 18, and, more specifically, through an adjacent interface 34 on lead 18, which reinforces the electrical connection between lead 18 and printed board 12. If lead 18 is insulated along its length, the insulation may be exposed to provide a contact through which second interconnect 32 may electrically connect to lead 18. The solder joints of second interconnect 32 to printed board 12 and lead 18 are not shown in FIG. 3. There may be examples in which second interconnect 32 is the only interconnect between printed board 12 and component 14, as described in further detail below.

Because second interconnect 32 is attached directly to the lead 18 and conductive pad 16, and provides a service loop between printed board 12 and component 14, second interconnect 32 may only be subjected to “local” stresses, e.g., generated by stress and strain forces from the local CTE mismatches of materials directly adjacent to the solder joints used to electrically (and mechanically) connect second interconnect 32 to lead 18 and conductive pad 16. In addition, second interconnect 32 has a lower elastic modulus than first lead 18, such that there is less stress at second interconnect 32 from the stress and strain cycles of assembly 30 (similar to those described above with respect to assembly 10 of FIGS. 1 and 2); the highly deformable material may just flow as the component 14/printed board 12 interface shear against one another. As a result of these features, the amount of stress and strain force applied to the interface between second interconnect 32 and printed board 12 and between second interconnect 32 and lead 18 may be lower than the amount of stress and strain applied to the interface between lead 18 and printed board 12 via solder joint 36. Thus, the electrical connection between second interconnect 32 and lead 18 may be more robust than the electrical connection between lead 18 and printed board 12.

In examples in which second interconnect 32 is more flexible than lead 18, second interconnect 32 may also be able to accommodate more movement between component 14 and printed board 12 (e.g., due to the relative expansion and contraction of component 14 and printed board 12) compared to the relatively stiff lead 18 (e.g., more movement without breakage or other effects, such as a reduction in signal integrity, that may affect the performance of the interconnect 32 or lead 18). While second interconnect 32 is indirectly connected to component 14 (and not hard mounted thereto), second interconnect 32 may still be subject to some stretching and pulling from movement of lead 18 during the relative expansion and contraction of component 14 and printed board 12. This may further help second interconnect 32 maintain an electrical connection to conductive pad 16 of printed board 12 and lead 18, even when the stress and/or strain generated by the thermal cycling is sufficient to fracture solder joint 36.

Solder joint 36 between pad 16 and lead 18 and second interconnect 32 provide redundant electrical pathways from component 14 to conductive pad 16 of printed board 12. In the event that solder joint 36 fails, the electrical pathway from component 14 to conductive pad 16 may still be maintained via the electrical pathway from conductive pad 16 to second interconnect 32, which is electrically connected to lead 18, which is itself electrically connected to component 14. In this way, second interconnect 32 may provide an electrically pathway that is partially redundant to the part of lead 18 between printed board 12 and interface 34, which is where lead 18 electrically connects to second interconnect 32.

Furthermore, even if solder joint 36 only partially cracks or fractures, such that some electrical connection through solder joint 36 remains, the resistance of the electrical pathway between lead 18 and contact pad 16 may increase. In these examples, second interconnect 32 may still improve the operation of printed board assembly 30 by providing a lower resistance electrical pathway from component 14 to printed board 12. Thus, printed board assembly 30 may be more robust than printed board assembly 10, which only includes a single electrical pathway from component 14 to conductive pad 16.

FIG. 4 is a flow diagram of an example technique for forming (e.g., assembling) printed board assembly 30. Second interconnect 32 may be electrically and mechanically connected to conductive pad 16 (40), e.g., via a soldering second interconnect 32 directly to conductive pad 16. In some examples, a eutectic solder can be positioned between interconnect 32 and conductive pad, and the subsequently reflowed, thereby electrically and mechanically connecting second interconnect 32 to conductive pad 16. In other examples, a high temperature solder may be used. Lead 18 may be electrically connected to conductive pad 16 through second interconnect 32 (42), e.g., by soldering (e.g., using a high temperature solder) lead 18 directly to second interconnect 32, thereby defining solder joint 36. In some examples, lead 18 may be preattached to component 14, such that electrically connecting lead 18 to conductive pad 16 may also include electrically and, in some examples, mechanically connecting component 14 to printed board 12.

The technique shown in FIG. 4 further includes electrically and mechanically connecting second interconnect 32 to lead 18 at interface 34 to define an at least partially redundant electrical pathway from lead 18 (and component 14) to conductive pad 16 (44). In some examples, second interconnect 32 is soldered to lead 18, e.g., via a high temperature solder, a eutectic solder, or another suitable technique.

The technique shown and described with respect to FIG. 4 may be performed in any suitable order, and is not limited to the order of blocks shown in FIG. 4. In addition, the technique shown and described with respect to FIG. 4 may be used with other printed board assemblies that include a first interconnect that electrically connects an electrical component to an electrically conductive pad on a printed board, and a second interconnect that electrically connects the electrically conductive pad to the first interconnect.

In some examples, each first interconnect (e.g., leads 18) of a printed board assembly may include a secondary interconnect (e.g., secondary interconnect 32) that provides an at least partially redundant electrical pathway between printed board 12 and electrical component 14. In other examples, however, a secondary interconnect may be used with only some first interconnects of a printed board assembly, such as only the first interconnects that may be more susceptible to fracture relative to other first interconnects. These first interconnects may be, for example, the corner leads 18 of printed board assembly 10 (e.g., the first 3-4 leads 18 on each corner). If the secondary interconnect causes component 14 to be spaced off printed board 12 (e.g., in the z-axis direction), the remaining leads (those without second interconnects) will either require a greater solder volume or require a placebo spacer which mimics part soldered to the pad and the foot of the lead. These pseudo secondary interconnects may only serve the purpose of occupying space and promoting more uniform attachment processes and may not define a redundant (fully or partially) electrical pathway from component 14 to printed board 12.

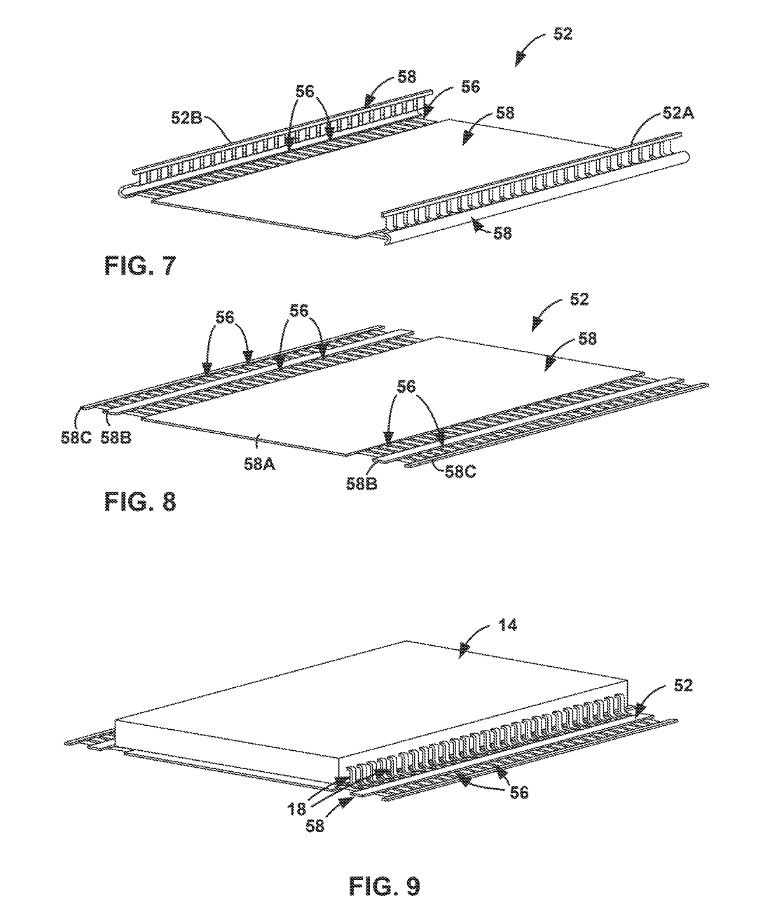

FIG. 5 is a side view of another example printed board assembly 50, which includes printed board 12 with a plurality of conductive pads 16, component 14, a plurality of leads 18, and a plurality of second interconnects 54. Printed board assembly 50 is similar to printed board assembly 30 (FIG. 3), but includes a different type of second interconnects 54. In particular, the plurality of second interconnects 54 are a part of a common flexible circuit 52. Flexible circuit 52 is also shown in FIGS. 7 and 8, which are perspective views of flexible circuit 52.

As FIGS. 7 and 8 illustrate, flexible circuit 52 includes a plurality of electrically conductive traces 56 that are electrically isolated from each other by electrically insulative substrate 58 in which traces 56 are secured. Traces 56 are formed from an electrically conductive material, such as copper (Cu). In some examples, the copper can be perforated, while in other examples, the copper can be substantially solid and devoid of perforations.

In the example shown in FIGS. 7 and 8, electrically insulative substrate 58 includes a first portion 58A, second portion 58B, and third portion 58C, which are described in further detail below. In the example shown in FIGS. 7 and 8, first portion 58A, second portion 58B and third portion 58C of electrically insulative substrate 58 mechanically space and hold adjacent electrically conductive traces 56 relative to each other. As a result, traces 56 may have fixed positions relative to each other. This configuration of traces 56 shown in FIGS. 7 and 8 may improve the ease with which flexible circuit 52 is manipulated, e.g., because traces 56 may move together as a group, rather than being a plurality of individual conductors that are movable relative to each other in six degrees of freedom. In some examples, flexible circuit 52 may be defined so that traces 56 are spaced to substantially match the spacing between conductive pads 16 on printed board 12, and/or the spacing of leads 18 relative to electrical component 14. As a result, when component 14 is placed on first portion 58A of electrically insulative substrate 58, ends 52A, 52B of flexible circuit 52 may be folded towards component 14 (e.g., as shown in FIGS. 5, 6, and 10) to bring traces 56 into contact with leads 18, and electrically and mechanically connect traces 56 to respective leads 18.

In other examples, electrically conductive traces 56 may define fingers at the ends 52A, 52B of flexible circuit 52, where the fingers are movable with respect to each other. As a result, flexible circuit 52 may be configured to provide an assembler of printed board assembly 50 more freedom in mechanically connecting leads 18 to respective electrically conductive traces 56 of flexible circuit 52.

As shown in FIG. 5, first portion 58A of flexible circuit 54 is positioned between component 14 and printed board 12. In some cases, a space may be present between component 14 and printed board 12 when component 14 is mounted to a surface of printed board 12. This space may be configured to accommodate the height of conductive pads 16 and solder joints between lead 18 and conductive pad 16. First portion 58A of substrate 58 of flexible circuit 52 may be configured to occupy this space in some of those examples. This may help further stabilize component 14 when component 14 is mounted to printed board 14.

In other examples of printed board assembly 50, flexible circuit 52 does not sit under the entire component 14 or any part of component 14. In some of these examples, multiple flexible circuits may be used to form electrical connections between leads 18 and respective contact pads 16, e.g., on different sides of component 14, rather than being a single flexible circuit that extends across two opposite sides of component 14, as shown in FIGS. 7 and 8.

Flexible circuit 52 is positioned relative to printed board 12 such that electrically conductive traces 56 substantially align with a conductive pad 16 of printed board 12. As with second interconnect 32 of printed board assembly 30 (FIG. 3), traces 56 may be soldered to respective conductive pads 16, such that the solder forms an electrical and mechanical connection between each trace 56 and respective conductive pad 16. In the example shown in FIGS. 5 and 6, each lead 18 is electrically connected to a conductive pad 16 through trace 56, i.e., trace 56 is positioned between lead 18 and conductive pad 16, such that lead 18 does not directly connect to pad 16 or only partially directly connects to pad 16. For example, lead 18 may be electrically and mechanically connected to the portion of trace 56 adjacent pad 16 via solder joint 36.

Electrically conductive trace 56 of flexible circuit 52 is also electrically connected to a respective lead 18. In the example shown in FIGS. 5 and 6, this electrical connection is made via solder joint 60. Flexible circuit 52 may be arranged relative to component 14 to help decrease the stress and strain at solder joint 60. In the example shown in FIG. 5, for example, circuit 52 is arranged to extend away from (e.g., protrude from) lead 18 (e.g., defining the “C” shape shown in FIG. 5), which may help relieve some strain and stress between lead 18 and flexible circuit 52. Second portion 58B of electrically insulative substrate 58 is positioned around the portion of trace 56 that protrudes from lead 18. In some examples, this portion of trace 56 may contact an adjacent trace 56, e.g., due to the flexibility of trace 56, such that it may be desirable to provide electrical isolation at this portion of trace 56 to help prevent cross-talk between the contacting traces.

Third portion 58C of electrically insulative substrate 58 is positioned around the end of trace 56. Again, end of trace 56 may inadvertently contact an adjacent trace 56 (e.g., defining a different electrical pathway), such that it may be desirable to provide electrical isolation at the end of trace 56. In addition to provide electrical isolation, third portion 58C of electrically insulative substrate 58 may also define an alignment tab that a user can grasp in order to align traces 56 of flexible circuit 52 to respective leads 18 during assembly of assembly 50.

In other examples, substrate 58 includes a fewer or greater number of portions. For example, in one example, substrate 58 may not include third portion 58C. In addition or instead, substrate 58 may not include second portion 58B. In another example the third portion 58C may include notched traces and be removed from the assembly after soldering as in a breakaway tab. In this example, the circuitry may be continuous on the periphery, e.g., as in a removable tie bar and not have any isolative substrate.

As shown in FIG. 5, when solder joint 36 between lead 18 and conductive pad 16 (flexible circuit 52 may be at least partially positioned between solder joint 36 and conductive pad 16) is intact, an electrical pathway 62 from component 14 to conductive pad 16 is defined by lead 18 and solder joint 36 which partially encompasses a portion of trace 56. As shown in FIG. 6, upon fracturing, cracking, or other disruption (e.g., failure) of solder joint 36, flexible circuit 52 provides an electrical pathway 64 from component 14 to conductive pad 16. In particular, electrical pathway 64 includes lead 18, solder joint 60, trace 56 of flexible circuit 52 and lower portion of solder joint 36 (e.g., adjacent conductive pad 16). In this way, flexible circuit 52 may provide an at least partially redundant electrical pathway from component 14 to printed board 12 when a primary electrical pathway 62 from component 14 to printed board 12 is intact, and may provide a back-up electrical pathway 64 from component 14 to printed board 12 when primary electrical pathway 62 from component 14 to printed board 12 is compromised. Furthermore, even if solder joint 36 only partially cracks or fractures, the resistance of the electrical pathway 62 between lead 18 and contact pad 16 may increase. In these examples, flexible circuit 52 may provide a lower resistance electrical pathway 64 from component 14 to printed board 12.

As shown in FIG. 6, secondary interconnects (e.g., traces 56 of flexible circuit 52) can be designed so they are placed in the portion of the solder joint that does not crack. Some solder joints are asymmetrical, such that the solder joint fails closer to component 14 than printed board 12. In some examples, secondary interconnects described herein may be placed in the larger volume of solder near conductive pad 16 of printed board 12; this volume of solder may be less susceptible to cracking than the volume of solder near lead 18, e.g., due to the stress and strain distribution during thermal cycling of printed board assembly 50.

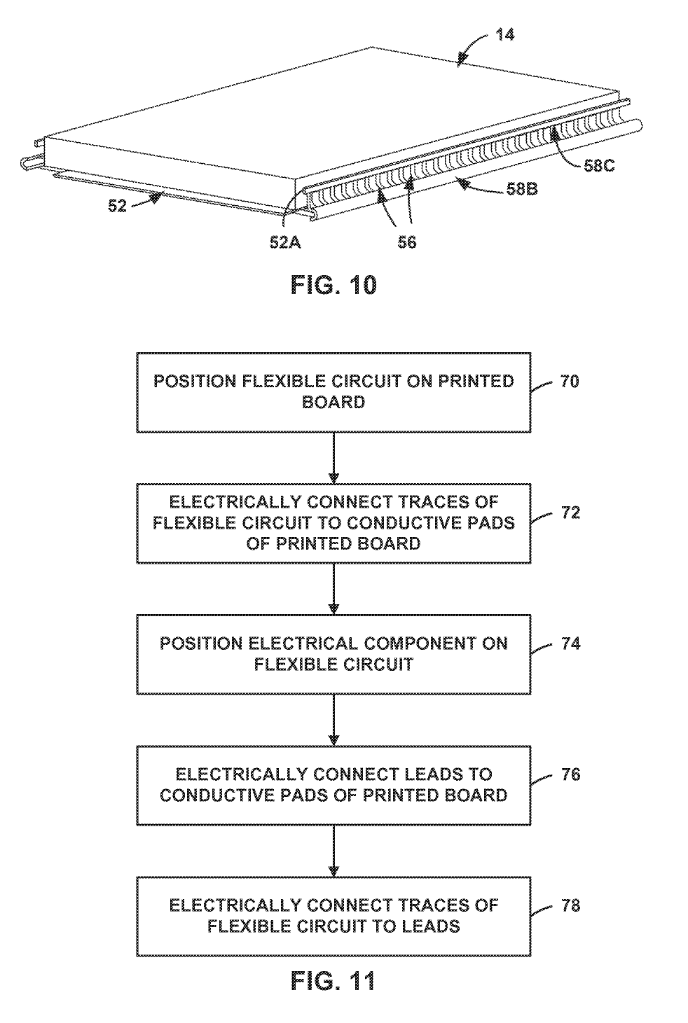

FIG. 9 is a perspective view of example flexible circuit 52 and component 14 prior to forming an electrical connection between each trace 56 and respective lead 18. In FIG. 9, flexible circuit 52 is in an unfolded state. Printed board 12 is not shown in FIG. 9. FIG. 10 is a perspective view of flexible circuit 52 and component 14 after ends 52A, 52B of flexible circuit 52 are folded over to align traces 56 with respective leads 18, and after forming electrical connections between each trace 56 and respective lead 18.

FIG. 11 is a flow diagram of an example technique for forming printed board assembly 50 (FIGS. 5-10). In FIG. 11, first portion 58A of electrically insulative substrate 58 of flexible circuit 52 is positioned on printed board 12 (70). Flexible circuit 52 is positioned such that exposed traces 56 substantially align with conductive pads 16 of printed board 12. In the example shown in FIG. 11, traces 56 are electrically connected to a conductive pads 16 (72), e.g., one trace 16 may be electrically connected to one conductive pad 16 or more than one conductive pad 16, or more than one trace 16 may be electrically connected to one conductive pad 16. For example, each of the traces 56 may be soldered (e.g., directly soldered) to one or more conductive pads 16 or a conductive adhesive may be positioned between traces 56 and the one or more respective conductive pads 16. In examples in which solder is used, pads 16 of printed board 12 may be pasted with solder, flexible circuit 52 may be aligned with the pads 16 (e.g., such that traces 56 are in electrical contact with the pads 16), and then the solder may be reflowed. In some examples, an adhesive or another technique (e.g., welding or brazing) is used to secure the position of flexible circuit 52 relative to printed board 12 in addition to the soldering or other technique used to electrically and mechanically connect flexible circuit to printed board 12.

Electrical component 14 may be positioned on flexible circuit 52 (74). In this step, component 14 may be aligned such that leads 18 are each aligned with a respective exposed trace 56 (e.g., such that an electrically conductive portion of a lead 18 is aligned with a respective electrically conductive portion of trace 56). If leads 18 are not yet attached to component 14, leads 18 may be attached to component 14 prior to or after component 14 is positioned on flexible circuit 52.

Leads 18 may then be electrically connected to conductive pads 16 (76). As described above, in some examples, a lead 18 may be electrically connected to one or more conductive pads 16 through an electrically conductive trace 56 of flexible circuit 52. For example, lead 18 may be soldered to an electrically conductive trace 56, which is itself electrically connected (e.g., via solder) to one or more conductive pads 16. As an example, solder may be pasted to the relevant parts of conductive trace 56, leads 18 may be aligned with respective traces 56, and then the solder may be reflowed. In other examples, a lead 18 may be electrically connected to one or more conductive pads 16 directly, e.g., via a solder joint. For example, lead 18 may electrically connect to a different portion of conductive pad 16 than the electrically conductive trace 56.

According to the technique shown in FIG. 11, electrically conductive traces 56 of flexible circuit 52 are each electrically connected to one or more respective leads 18 (78), e.g., via solder 60 (FIGS. 5 and 6). Solder 60 may be, for example, placed via a high temperature solder or via a eutectic solder.

The technique shown and described with respect to FIG. 11 may be performed in any suitable order. In addition, the technique shown and described with respect to FIG. 11 may be used with other printed board assemblies that include a flexible circuit.

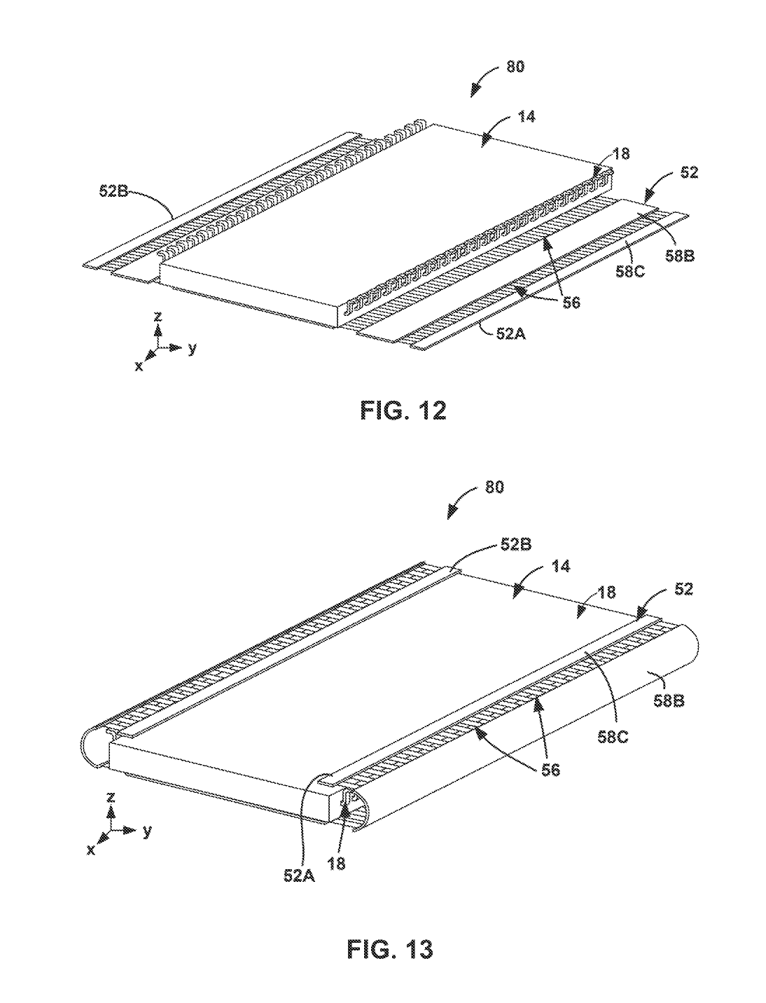

In some examples of printed board assemblies that include flexible circuit 52 and component 14, component 14 may be mounted in another orientation. FIGS. 12 and 13 are conceptual perspective views of a portion of an example printed board assembly 80, which includes flexible circuit 52 and component 14. As shown in FIG. 12, component 14 is mounted upside down (e.g., rotated 180 degrees in the z-axis direction, where x-y-z axes are shown in FIG. 12 for ease of description only) relative to the orientation of component 14 in printed board assembly 50 (FIGS. 5-10). As a result, leads 18 are electrically connected to a different portion of traces 56 in printed board assembly 80 than in printed board assembly 50.

FIG. 12 illustrates flexible circuit 52 and component 14 prior to the formation of an electrical connection between each trace 56 and respective lead 18. In FIG. 12, flexible circuit 52 is in an unfolded state, in which the ends 52A, 52B of circuit 52 are not wrapped around component 14. Printed board 12 is not shown in FIGS. 12 or FIG. 13. FIG. 13 is a perspective view of flexible circuit 52 and component 14 after ends 52A, 52B of flexible circuit 52 are folded over to align traces 56 with respective leads 18, and after forming electrical connections between each trace 56 and respective lead 18.

In some examples, when component 14 and flexible circuit 52 are in the example configuration shown in FIG. 13, flexible circuit 52 may be mounted to printed board 12 such that component 14 is positioned between first portion 58A of substrate 58 and printed board 12. In these examples, traces 56 of flexible circuit 52 may provide a similar redundant electrical pathway and back-up electrical pathway between component 14 and printed board 12 in a manner similar to that shown in FIGS. 5 and 6.

In other examples, flexible circuit 52 may be mounted to printed board 12 such that first portion 58A of substrate 58 is positioned between component 14 and printed board 12, e.g., as shown in FIGS. 5 and 6. In these examples, the electrical pathway from component 14 to printed board 12 via leads 18 may be from lead 18, through a trace 56, to conductive pad 16 of lead. The pathway from lead 18 to conductive pad 16 through trace 56 may be longer than in the example shown in FIGS. 5 and 6, in which component 14 is rotated 180 degrees. In addition, in this example, printed board assembly 80 does not include redundant (partially or fully) electrical pathways from component 14 to printed board 12 or a direct electrical pathway from lead 18 to a conductive pad 16 of printed board 12. Rather, conductive traces 56 of flexible circuit 52 may define the only electrical pathway from component 14 to printed board 12. Thus, in some examples, leads 18 are not electrically connected to conductive pads 16 via a pathway other than through conductive traces 56.

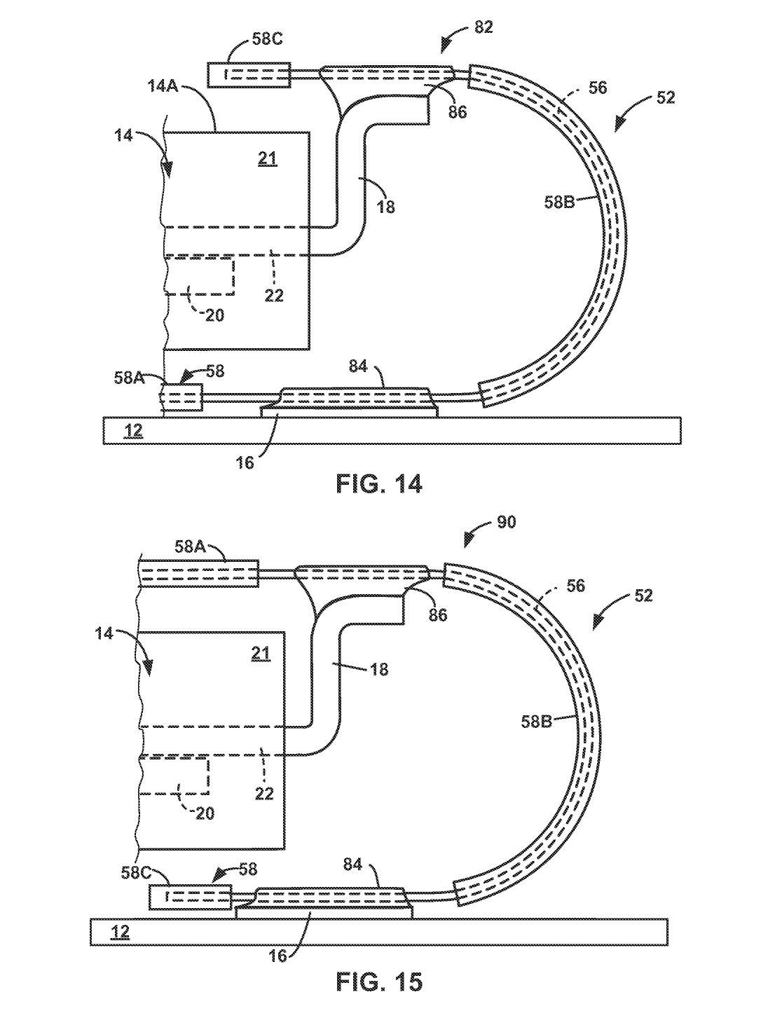

FIG. 14 is a side view of another example printed board assembly 82 that only includes one electrical pathway between component 14 and printed board 12. Assembly 82 includes printed board 12 with a plurality of conductive pads 16, component 14, lead 18, and flexible circuit 52. As discussed above, one example of component 14 includes integrated circuit 20, package 21, and lead frame 22. In the example shown in FIG. 14, component 14 is mounted on printed board 12 such that surface 14A that is adjacent printed board 12 in printed board assembly 50 (FIGS. 5-10) is no longer adjacent printed board 12. That is, in FIG. 14, component 14 is inverted in the z-axis direction relative to the orientation of component 14 in printed board assembly 50.

Flexible circuit 52 is arranged such that first portion 58A of substrate 58 is positioned between component 14 and printed board 12. In some examples, an additional mechanism can be used to secure the position of component 14 relative to printed board 12, e.g., to improve the vibrational resilience of component 14. For example, an adhesive may be used to adhere component 14, flexible circuit 52, or both, to printed board 12.

In printed board assembly 82, leads 18 are not directly electrically connected to contact pads 16 of printed board 12. Rather, electrically conductive traces 56 of flexible circuit 52 define the only electrical pathway between component 14 and printed board 12. In the example shown in FIG. 14, electrically conductive trace 56 is electrically connected to conductive pad 16 via solder 84. Electrically conductive trace 56 can be electrically connected to one or more conductive pads 16, depending upon the desired configuration of printed board assembly 82. In addition, in the example shown in FIG. 14, electrically conductive trace 56 (a portion on the other side of portion 58B of substrate 58) is electrically connected to lead 18 via solder 86. Thus, lead 18 is more indirectly electrically connected to conductive pad 16 in the example shown printed board assembly 82 relative to, e.g., printed board assembly 50.

Inverting component 14 such that leads 18 electrically connect to traces 56 at a region relatively far from printed board 12 (e.g., relative to printed board assembly 50), and such that lead 18 does not electrically connect to conductive pad 16 near conductive pad 16 (e.g., as in printed board assembly 50) may help reduce any stress and strain exerted on the electrical connection between lead 18 and conductive pad 16 due to global CTE mismatch (e.g., between component 14 and printed board 12). Flexible circuit 52 may be configured to better accommodate relative movement between printed board 12 and component 14 compared to lead 18. Inversion of component 14 may require pads 16 on printed board 12 to be transposed compared to the arrangement used in printed board assembly 50.

In FIGS. 14 and 15, ends 58C of flex circuit 58 may aid in the assembly alignment process and maybe designed to be removed, e.g., after assembly of printed board assembly 82. For example, traces 56 may include notches that augment removal by subsequent bending. Traces 56 may include other types of frangible seams in other examples. Additionally or alternatively, these ends may be of the breakaway tie bar configuration with or without electrical insulation (e.g., Kapton insulation).

FIG. 15 is a side view of another example printed board assembly 90 that only includes one electrical pathway between component 14 and printed board 12. Printed board assembly 90 is similar to printed board assembly 82 (FIG. 14), but in printed board assembly 90, flexible circuit 52 is inverted relative to the orientation in printed board assembly 82. The electrical pathway from lead 18 to conductive pad 16 of printed board 12 is longer in printed board assembly 90 than in printed board assembly 82.

An inverted component 14, as shown in FIGS. 14 and 15, may help eliminate or minimize global CTE mismatch of the printed board assemblies.

In other examples of printed board assemblies, flexible circuit 52 may have other orientations relative to component 14 and/or printed board.

A secondary interconnect can be electrically and mechanically attached to a printed board and an electrical component using any suitable technique. Some types of secondary interconnects, such as flexible circuits, may support different assembly methods. For example, in one technique, eutectic solder may be used to electrically and mechanically connect a first interconnect (e.g., lead 18) to conductive pad 16 (e.g., directly or indirectly through a portion of trace 56) and component 14, and a high temperature solder may be used to electrically and mechanically connect the secondary interconnect to printed board 12 and the first interconnect. As another example, the first interconnect can electrically and mechanically connected to conductive pad 16 and component 14 via a eutectic solder, and a secondary interconnect can be electrically and mechanically connected to printed board 12 and the first interconnect via a eutectic solder.

As yet another example, the first interconnect can electrically and mechanically connected to conductive pad 16 and component 14 via a eutectic solder, and these interfaces can be reinforced with solder reflow, and a secondary interconnect can be electrically and mechanically connected to printed board 12 and the first interconnect via a eutectic solder. In addition, in another example, flexible circuit 52 may be soldered to component 14 and lead 18 with a relatively high temperature solder and then the preassembled flex circuit/component assembly may be soldered to printed board 12 with eutectic solder. The relatively high temperature solder joints may be configured such that they do not reflow when the eutectic solder joints are reflowed.

In other examples, the devices, systems, and techniques described herein may be used to electrically connect electrical components to a printed board assembly that includes electrical contact pads on opposing sides. In addition, in some examples, a flexible circuit described herein may be used as an intermediate printed board that is attached to a rigid printed board. Further, in some examples, the flexible circuit may include two or more circuitry layers.

Various examples have been described. These and other examples are within the scope of the following claims.

What is claimed is:

1. An assembly comprising:
a printed board;
an electrical component;
a first interconnect electrically connecting the electrical component to the printed board; and
a second interconnect electrically connecting the printed board and the first interconnect, wherein the first and second interconnects are configured to provide at least partially redundant electrical pathways between the electrical component and the printed board.

2. The assembly of claim 1, wherein the printed board comprises an electrically conductive contact, and wherein the first interconnect extends between the electrically conductive contact and the electrical component, and the second interconnect extends between the first interconnect and the electrically conductive contact.

3. The assembly of claim 2, wherein the second interconnect is positioned between first interconnect and the electrically conductive contact.

4. The assembly of claim 1, further comprising a solder joint electrically connecting the first and second interconnects.

5. The assembly of claim 1, wherein the second interconnect indirectly electrically connects to the electrical component via first interconnect.

6. The assembly of claim 1, wherein the first interconnect indirectly electrically connects to the printed board via the second interconnect.

7. The assembly of claim 1, further comprising a flexible circuit comprising a plurality of electrically conductive traces, wherein the second interconnect comprises at least one electrically conductive trace of the plurality of electrically conductive traces of the flexible circuit.

8. The assembly of claim 7, wherein the flexible circuit is positioned between the electrical component and the printed board.

9. The assembly of claim 8, wherein the printed board comprises an electrically conductive contact, and at least one electrically conductive trace of the plurality of electrically conductive traces of the flexible circuit board is electrically connected to the electrically conductive contact.

10. The assembly of claim 1, wherein the second interconnect is more flexible than the first interconnect

11. The assembly of claim 1, wherein the second interconnect comprise a perforated portion, the perforated portion being positioned between first interconnect and printed board.

12. An assembly comprising:
a printed board;
an electrical component;
means for electrically connecting the electrical component to the printed board; and
means for electrically connecting the printed board and the means for electrically connecting the electrical component to the printed board, wherein the means for electrically connecting the electrical component to the printed board and the means for electrically connecting the printed board and the means for electrically connecting the electrical component to the printed board provide at least partially redundant electrical pathways between the electrical component and the printed board.

13. The assembly of claim 12, wherein the printed board comprises an electrically conductive contact, and wherein the means for electrically connecting the electrical component to the printed board extends between the electrically conductive contact and the electrical component, and the means for electrically connecting the printed board and the means for electrically connecting the electrical component to the printed board extends between the first interconnect and the electrically conductive contact.

14. The assembly of claim 12, wherein the means for electrically connecting the printed board and the means for electrically connecting the electrical component to the printed board is positioned between the means for electrically connecting the electrical component to the printed board and the printed board.

15. A method of creating a circuit assembly, the method comprising:
electrically connecting a first interconnect to a printed board;
electrically connecting the first interconnect to an electrical component;
electrically connecting a second interconnect to the printed board; and
electrically connecting the second interconnect to the first interconnect to define an at least partially redundant electrical pathway from the electrical component to the printed board.

16. The method of claim 15, wherein the electrically connecting the first interconnect to the printed board comprises positioning the second interconnect between the first interconnect and an electrically conductive contact of the printed board and electrically connecting the first interconnect to the electrically conductive contact via the second interconnect.

17. The method of claim 15, wherein electrically connecting the second interconnect to the printed board comprises soldering the second interconnect directly to an electrically conductive contact of the printed board.

18. The method of claim 15, wherein electrically connecting the first interconnect to the printed board comprises soldering the first interconnect to an electrically conductive contact of the printed board through perforations defined by the second interconnect.

19. The method of claim 15, wherein electrically connecting the second interconnect to the first interconnect comprises soldering the first interconnect to the second interconnect.

20. The method of claim 15, wherein the second interconnect comprises an electrically conductive trace of a flexible circuit, and wherein electrically connecting the first interconnect to the printed board comprises:
electrically connecting the first interconnect to the electrically conductive trace; and
electrically connecting the electrically conductive trace to the printed board, wherein the first interconnect indirectly electrically connects to the printed board via the electrically conductive trace.
